(19) United States
(12) Patent Application Publication
(10) Pub. No.: US 2002/0189194 A1
(43) Pub. Date: Dec. 19, 2002

(54) Apparatus for temporarily supporting a fascia board

(76) Inventors: Cathy D. Santa Cruz, Reno, NV (US); Gary Potter, Doyle, CA (US)

Correspondence Address: Cathy D. Santa Cruz, 7630 Tholl Drive, Reno, NV, 89506, US

(21) Appl. No.: 09/882,568

(22) Filed: Jun. 15, 2001

(51) Int. Cl. B25B 11/02

(52) U.S. Cl. 52/749.1; 52/94; 269/41; 269/904

(57) ABSTRACT

An apparatus which is used for temporarily supporting a fascia board during the installation process and includes at least one adjustable bracket which allows any sized fascia board to be easily mounted at variable angles choice.

### FIELD OF THE INVENTION

This invention relates to support brackets or the like but more particularly pertains to a pair of support brackets which when used in combination aid a workman and simplify installation of a fascia board during mounting onto a support structure.

### BACKGROUND OF THE INVENTION

The typical construction of the roof section of frame for a building includes a number of parallel “rafters” that extend from the peak beam of the roof down a lower edge where the rain gutter is mounted and the rafters are conventionally spaced twenty-four inches apart. According to construction practice, after the rafters have been secured in place, a fascia board is nailed across the lower ends of the rafters. The operation of securing the fascia board in place requires the board to be held horizontally against all of the ends of the rafters by two carpenters, one carpenter supporting each end of the board. This is a very dangerous operation since it requires that each carpenter must somehow support himself usually at least two stories from the ground, support his end of the board and simultaneously hammer a nail through the fascia board and the end of the eave. This practice is not only very dangerous for the workers, but this is also extremely costly when considering that two workers must be employed for completion of the job rather than one. Thus, it would be very advantageous to provide means for the process to be easily performed by only one worker.

It is to be understood that this problem has been recognized and addressed in various prior art. However, no where in the prior art did the applicants find an apparatus such as the present invention which resolves the problem in an appropriate manner which is cost effective, safe, allows for installation of various sized fascia boards, and allows for the fascia board to be mounted at any suitable angle of user choice.

Within the known prior art, various attempts have been made to resolve the noted problem but each have inherent drawbacks which the present invention recognizes, addresses and resolves in a manner heretofore not taught.

For example, in U.S. Pat. No 6,209,280 entitled “JIG FOR SUPPORTING FASCIA BOARD INSTALLATION” they provide a pair of U-shaped brackets which are removably attachable to the rafters of the building. Unfortunately, this system is not completely functional as it does not allow variable adjustment which is most beneficial when mounting the fascia board at different angles. Also, the system is not functional for use with fascia boards of varying sizes as the U-shaped bracket can only hold one size. Still further the U-shaped bracket must be made from a flexible polycarbonate which allows the workman to bend or twist the bracket into an appropriate configuration. This practice is not only time consuming but also tends to weaken the bracket over time and is therefore again costly.

Another example is taught within U.S. Pat. No. 5,611,189 entitled “APPARATUS FOR HANGING FASCIA BOARD”. Wherein they provide a bracket such as described above but further includes an additional extension member which allows the bracket to be variably positioned at a different height. This is somewhat useful as this allows for a fascia board having a different height to be adjustably mounted, but again this device is limited to use with a fascia board having only one predetermined width and mounting a fascia board at an angle other than 45 degrees would be most difficult.

Other examples include U.S. Pat. Nos. 5,088,682 and 5,192,059, each of which teach complicated assemblies having numerous parts which the present invention clearly eliminates and each function in completely different manners.

### SUMMARY OF THE INVENTION

It is therefore an object of the present invention to provide an apparatus for temporarily supporting a fascia board which is simple in construction, is economical to produce, and eliminates the need for two workers during installation as the job can easily be accomplished by only one worker.

It is another object of the present invention to provide an apparatus for temporarily supporting a fascia board which is completely adjustable and is thus functional for mounting various sizes of fascia boards.

Still another object is to provide an apparatus for temporarily supporting a fascia board which allows the user he option of making adjustments prior to mounting of the apparatus. Heretofore the known prior art devices are limited in use because in most cases any adjustments must be made during the installation process, unlike the present invention.

Yet another object of the present invention is to provide an apparatus for temporarily supporting a fascia board which is easily used for mounting a fascia board at any suitable angle of user choice.

Still another object of the present invention is to provide an apparatus for temporarily supporting a fascia board which can be made from substantially any non-flexible material of engineering choice, such as wood, steel, aluminum, plastic, Nylon, etc.

Also, a further object of the present invention is to provide an apparatus for temporarily supporting a fascia board which is very easy to use and saves the worker wasted time, which in turn is most cost effective.

Yet another object of the present invention is to provide an apparatus for temporarily supporting a fascia board which may include indicia thereon corresponding to the pivotable angular relationship between the apparatus and the fascia board to be mounted.

A further object of the present invention is to provide an apparatus for temporarily supporting a fascia board which may include indicia thereon corresponding to the size of the fascia board to be mounted.

Also another object of the present invention is to provide an apparatus for temporarily supporting a fascia board which may include a roller so as to allow the workman to easily position the fascia board into the exact location of choice.

Other objects and advantages will be seen when taken into consideration with the following drawings and specification.

### BRIEF DESCRIPTION OF THE DRAWINGS

FIG. 1 is substantially a plan view of the preferred embodiment for the present invention and further depicting a front view of a right side bracket.

FIG. 2 is substantially a front view depicting a left side bracket.

FIG. 3 is substantially a front view depicting various adjustments and associated indicia.

FIG. 4 is substantially a partial front view depicting one possible attachment means when in a first position.

FIG. 5 is substantially a partial front view depicting the above noted attachment means when in a second position.

FIG. 6 is substantially a partial front view depicting a different type of attachment means.

FIG. 7 is substantially a top view of FIG. 7.

### DETAILED DESCRIPTION OF THE DRAWINGS

Referring now in detail to the drawings wherein like characters refer to like elements throughout the various views.

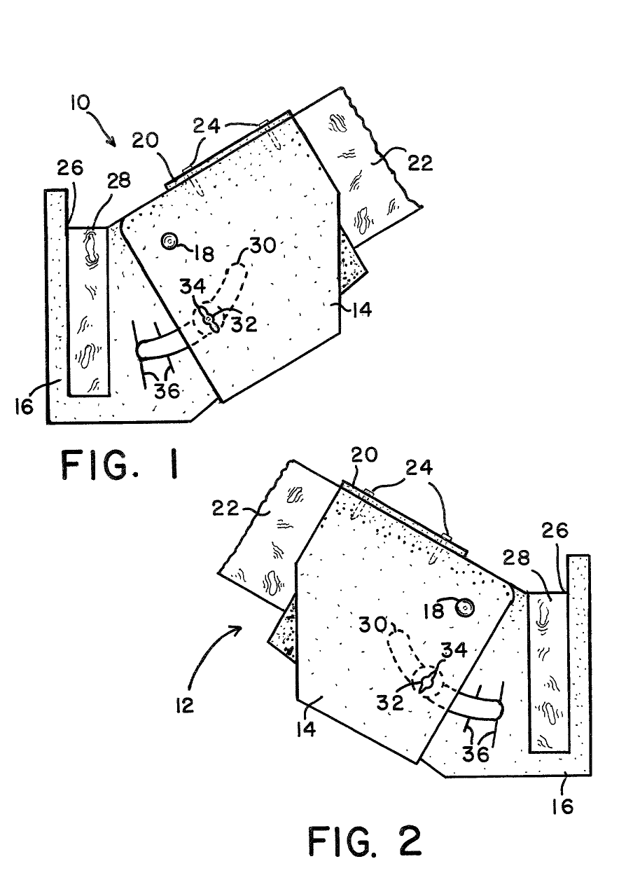

FIG. 1 is substantially a plan view for the present invention showing the apparatus when being used for temporarily supporting a fascia board. It is to be understood that the present apparatus can be used as a single bracket or as a pair of brackets depending on user choice. It is to be further understood that each of the brackets can be identical in shape and size if so desired, or they can be formed as a right side bracket (10) as depicted in FIG. 1 and a left side bracket (12) as depicted in FIG. 2, each of which are described within the following specification.

Referring now to FIGS. 1 & 2 wherein each bracket (10 & 12) is formed from a first support member (14) and a second support member (16), with first support member (14) being substantially positioned on top of second support member (16) along the same plane. First support member (14) and second support member (16) being pivotably attached together by suitable attachment means of engineering choice, such as by a conventional pivot pin (18) or the like.

First support member (14) having a protruding lip (20) which includes attachment means of engineering choice for removably affixing first support member (14) onto a support structure (22). For example, protruding lip (20) may be simply attached by any suitable fastener, such as at least one nail (24) or the like, and the support structure can be any suitable support structure (22) of choice, such as the roof of a building or the like.

Second support member (16) having a recess (26) which is of a shape and size to slidably receive a conventional fascia board (28) therein. Also, first support member (14) and second support member (16) in combination have suitable adjustment means of engineering choice for variably adjusting the pivotable angular relationship between first support member (14) and second support member (16). It is to be understood any suitable adjustment means may be utilized, such as a curved cutout section (30) which is substantially formed within second support member (16) and which is of a shape and size to receive a suitable fastener there through, with the fastener having means for being fixedly secured in place, and first support member (14) includes an opening (32) for receiving the fastener therein. It is to be understood any suitable fastener may be used of engineering choice, such as a wing-nut (34) which can be easily secured in place with a washer and nut (not shown) for clarity purposes.

Whereby, it can now be seen that when each bracket (10 & 12) are temporarily affixed in place and the pivotable angular relationship between first support member (14) and second support member (16) of each bracket (10 & 12) is adjustably secured, the fascia board (28) can be slidably easily engaged between each bracket (10 & 12) within each recess (26) and temporarily held in a secure manner until the installation is complete. Thereafter, the worker can easily remove the brackets (10 & 12) until needed again.

It is to be understood the embodiment as described above is most functional as is. However, the following specification includes additional options which the applicants contend may be useful.

Referring now to FIGS. 1 & 2, wherein we illustrate that if so desired, second support member (16) may include indicia (36) thereon which substantially corresponds to the pivotable angular relationship between the first support member (14) and second support member (16). For example, if a worker is mounting a fascia board (28) onto a support structure (22) having a 30 degree pitch, then the worker simply aligns the edge of first support member (14) with a line corresponding to the numeral thirty. Thus, assuring that the fascia board (28) will be mounted properly at the desired angle.

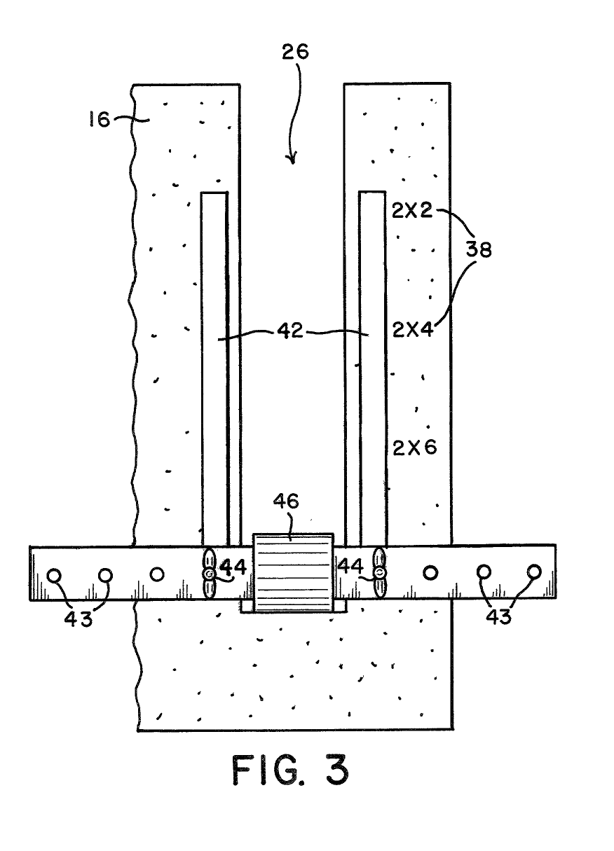

Another option as illustrated in FIG. 3 which is to be included within the present invention, is to provide recess (26) with appropriate adjustment means for varying the depth of recess (26). For example, an appropriate adjustment means includes a removable cross bar (40) which can be easily variably positioned across recess (26) and secured in place at various locations according to user choice. In this embodiment, second support member (16) includes multiple slots (42) and cross bar (40) includes holes (43) which can be easily aligned and mated with holes (42) and Cross bar (40) includes appropriate fastener means (44) therewith for securing cross bar (40) within corresponding holes (42). Also, if desired cross bar (40) may further include a roller (46) mounted thereon. It is to be understood the roller (46) may be installed alone within recess (26) if cross bar (40) is not used, as cross bar (40) is only an example of one mounting means for roller (46). Thus, in either case, the fascia board (28) can be easily slidably positioned between each bracket (10 & 12) at a location of choice. It is to be further understood that cross bar (40) as depicted in FIG. 3, is shown having an extended length which is used for additional options hereafter described, but cross bar (40) can be any suitable length of engineering choice.

Another option as illustrated in FIG. 3 which is to be included within the present invention, is to provide further information for the worker, such as indicia (38) which substantially corresponds to the size of fascia board (28) so as to allow the worker to easily determine the proper depth for recess (26). For example, if the worker is mounting a fascia board (28) which substantially measures 2 ×4, then they would locate the corresponding indicia (38) and the above noted cross bar (40) can then be easily positioned and secured accordingly.

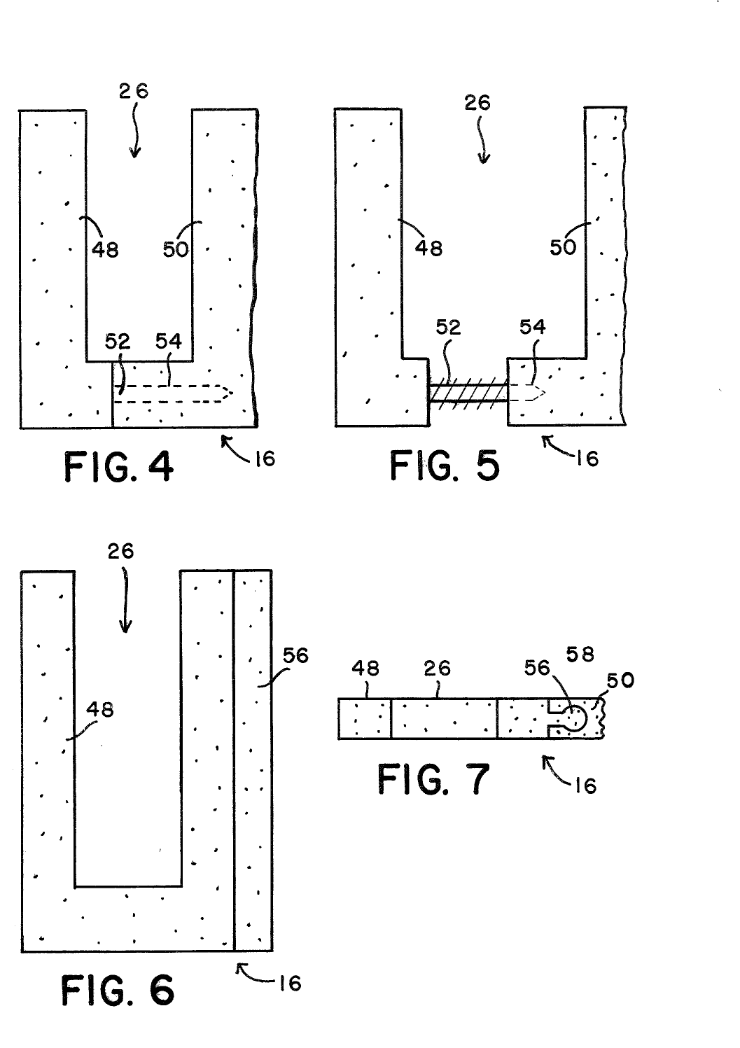

Referring now to FIGS. 4 & 5 which depict yet another option for the present invention. Wherein, second support member (16) is substantially formed from a first section (48) and a second section (50), with first section (48) and second section (50) having appropriate attachment means for removably attaching first section (48) and second section (50) together, and first section (48) and second section (50) in combination forming previously noted recess (26) for slidably receiving fascia board (28) therein. Whereby, first section (48) and second section (50) provide adjustment means for varying the width of recess (26). For example, one appropriate adjustment means is depicted in FIGS. 4 & 5, wherein first section (48) includes a fixedly embedded protruding threaded screw (52) and second section (50) includes a threaded hole (54) for threadably receiving threaded screw (52) therein. Whereby, depending on how far threaded screw (52) is threadably engaged within threaded hole (54) inadvertently varies the width of recess (26). Such as illustrated in FIG. 4, when threaded screw (52) is completely threadably engaged, the width of recess (26) is reduced. While as illustrated in FIG. 5, when threaded screw (52) is only partially threadably engaged, the width of recess (26) is greatly increased. Thus it can clearly be seen that recess (26) can be easily adjusted to accept fascia boards (28) of different widths.

The above is exemplary of one possible attachment means for removably attaching first section (48) and second section (50) together. However, another appropriate attachment means is disclosed in FIGS. 6 & 7, wherein first section (48) includes an elongated protrusion (56) and second section (50) includes an elongated niche (58) which is of a shape and size to slidably receive elongated protrusion (56) therein. It can now be seen this embodiment would be sold as a kit including various sizes of first section (48), with each of the various sizes of first section (48) providing a different width for recess (26). Whereby, a user can easily interchange the various sizes of first section (48) so as to accommodate different sizes of fascia boards (28).

It is to be understood the present invention also teaches a unique method of use, comprising the steps of:

a. positioning a right bracket (10) on a support structure (22) at the desired location;

b. attaching right bracket (10) onto support structure (22) with a fastener (24);

c. adjusting the pivotable angular relationship between first support member (14) and second support member (16) of right bracket (10);

d. securing the pivotable angular relationship on right bracket (10) with fastener (34);

e. positioning a left bracket (12) on a support structure (22) at the desired location;

f. attaching left bracket (12) onto support structure (22) with a fastener (24);

g. adjusting the pivotable angular relationship between first support member (14) and second support member (16) of left bracket (12);

h. securing the pivotable angular relationship on left bracket (12) with fastener (34);

i. inserting and slidably positioning a fascia board (28) within each bracket (10 & 12) into the desired position; and;

j. securing fascia board (28) in place with fasteners.

It will now be seen we have herein provided an apparatus for temporarily supporting a fascia board (28) which is simple to use by only one worker, is portable, is economical, safe, easily attached and removed, and most importantly overcomes the inherent disadvantages associated within the known prior art.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus's.

What we claim as new and wish to secure by Letters Patent is:

1. An apparatus for temporarily supporting a fascia board comprising: a right side bracket and a left side bracket; each said bracket being formed from a first support member and a second support member, said first support member being positioned on top of said second support member along the same plane, said first support member and said second support member being pivotably attached together, said first support member having a protruding lip, said protruding lip having attachment means for removably affixing said first support member onto a support structure, said second support member having a recess for slidably receiving a fascia board therein, and said first support member and said second support member in combination having adjustment means for variably adjusting the pivotable angular relationship between said first support member and said second support member,
whereby:
when each said bracket is temporarily affixed in place and said pivotable angular relationship between said first support member and said second support member of each said bracket is adjustably secured, said fascia board can be slidably engaged between each said bracket within each
said recess and temporarily held in a secure manner.

2. The apparatus of claim 1 wherein said attachment means for removably affixing said first support member onto a support structure includes at least one fastener.

3. The apparatus of claim 1 wherein said adjustment means includes a curved cutout section formed within said second support member, said curved cutout section being of a shape and size to receive a fastener there through, said fastener having means for being fixedly secured, and said first support member having an opening for receiving said fastener therein.

4. The apparatus of claim 3 wherein said fastener is a wing-nut and said means for being fixedly secured is a washer and nut.

5. The apparatus of claim 1 further includes indicia thereon corresponding to said pivotable angular relationship.

6. The apparatus of claim 1 wherein said recess includes adjustment means for varying the depth of said recess.

7. The apparatus of claim 6 further includes indicia thereon corresponding to the size of said fascia board.

8. The apparatus of claim 6 wherein said adjustment means includes a removable cross bar which can be easily variably positioned and secured in place at various locations.

9. The apparatus of claim 1 wherein said recess includes a roller,
whereby:
said fascia board can be easily slidably positioned between each said bracket at a location of choice.

10. An apparatus for temporarily supporting a fascia board comprising: a right side bracket and a left side bracket; each said bracket being formed from a first support member and a second support member, said first support member being positioned on top of said second support member along the same plane, said first support member and said second support member being pivotably attached together, said first support member having a protruding lip, said protruding lip having attachment means for removably affixing said first support member onto a support structure, said second support member being formed from a first section and a second section, said first section and said section having attachment means for removably attaching said first section and said second section together, said first section and said second section in combination forming a recess for slidably receiving a fascia board therein, and said first support member and said second support member in combination having adjustment means for variably adjusting the pivotable angular relationship between said first support member and said second support member,
whereby:
when each said bracket is temporarily affixed in place and said pivotable angular relationship between said first support member and said second support member of each said bracket is adjustably secured, said fascia board can be slidably engaged between each said bracket within each said recess and temporarily held in a secure manner.

11. The apparatus of claim 10 wherein said first section and said second section in combination include adjustment means for varying the width of said recess.

12. The apparatus of claim 11 wherein said adjustment means comprises: said first section having a fixedly embedded protruding threaded screw and said second section having a threaded hole for threadably receiving said threaded screw therein,
whereby:
depending on how far said threaded screw is engaged within said threaded hole inadvertently varies the width of said recess.

13. The apparatus of claim 10 wherein said first section and said section having attachment means for removably attaching said first section and said second section together comprising: said first section having an elongated protrusion, said second section having an elongated niche, and said elongated niche being of a shape and size to slidably receive said elongated protrusion therein.

14. The apparatus of claim 13 is sold as a kit, said kit including various sizes of said first section, said various sizes of said first section each providing a different width for said recess,
whereby;
a user can easily interchange said various sizes of said first section so as to accommodate different sizes of said fascia board.

15. An apparatus for temporarily supporting a fascia board comprising: a bracket; said bracket being formed from a first support member and a second support member, said first support member being positioned on top of said second support member along the same plane, said first support member and said second support member being pivotably attached together, said first support member having a protruding lip, said protruding lip having attachment means for removably affixing said first support member onto a support structure, said second support member having a recess for slidably receiving a fascia board therein, and said first support member and said second support member in combination having adjustment means for variably adjusting the pivotable angular relationship between said first support member and said second support member,
whereby:
when said bracket is temporarily affixed in place and said pivotable angular relationship between said first support member and said second support member of said bracket is adjustably secured, said fascia board can be slidably engaged within said recess of said bracket and temporarily held in a secure manner.
